(19) United States
(12) Patent Application Publication
(10) Pub. No.: US 2017/0272588 A1
(43) Pub. Date: Sep. 21, 2017

(54) INFORMATION PROCESSING SYSTEM AND INFORMATION PROCESSING METHOD

(71) Applicant: Kunihiro AKIYOSHI, Fukuoka (JP)

(72) Inventor: Kunihiro AKIYOSHI, Fukuoka (JP)

(73) Assignee: Ricoh Company, Ltd., Tokyo (JP)

(21) Appl. No.: 15/449,059

(22) Filed: Mar. 3, 2017

(30) Foreign Application Priority Data
Mar. 15, 2016 (JP) 2016-050529

(51) Int. Cl. H04N 1/00; H04N 1/32

(52) U.S. Cl. CPC H04N 1/00344; H04N 1/00244; H04N 1/00079; H04N 1/00408; H04N 1/32101; H04N 1/32662; H04N 2201/0094

(57) ABSTRACT

An information processing system includes an information processing terminal and a device. The device includes a first display unit configured to display a screen and a transmitting unit configured to transmit identification information relating to the screen being displayed by the first display unit to the information processing terminal. The information processing terminal includes a receiving unit configured to receive the identification information from the device, an acquiring unit configured to acquire data corresponding to the received identification information, and a second display unit configured to display the acquired data.

### CROSS-REFERENCE TO RELATED APPLICATIONS

The present application claims priority under 35 U.S.C. §119 to Japanese Patent Application No. 2016-050529 filed on Mar. 15, 2016, the entire contents of which are incorporated herein by reference.

### BACKGROUND OF THE INVENTION

1. Field of the Invention

The present disclosure relates to an information processing system and an information processing method.

2. Description of the Related Art

Various types of devices including image forming apparatuses that enable a user to install an application program (simply referred to as “application” hereinafter) are known. Instruction manuals and online help are common support tools that provide guidance to users on how to use the application. Because operating a device while viewing an instruction manual is not easy in practice, enhancement of online help functions is desired in order to improve convenience for the user.

### SUMMARY OF THE INVENTION

According to one embodiment of the present invention, an information processing system is provided that includes an information processing terminal and a device. The device includes a first display unit configured to display a screen and a transmitting unit configured to transmit identification information relating to the screen being displayed by the first display unit to the information processing terminal. The information processing terminal includes a receiving unit configured to receive the identification information from the device, an acquiring unit configured to acquire data corresponding to the received identification information, and a second display unit configured to display the acquired data.

### BRIEF DESCRIPTION OF THE DRAWINGS

FIG. 1 is a diagram illustrating an example configuration of an information processing system according to a first embodiment of the present invention;

FIG. 2 is a diagram illustrating an example hardware configuration of an image forming apparatus according to the first embodiment;

FIG. 3 is a diagram illustrating an example hardware configuration of an information processing terminal according to the first embodiment;

FIG. 4 is a diagram illustrating an example functional configuration of the information processing system according to the first embodiment;

FIG. 5 is a flowchart illustrating example process operations executed by the image forming apparatus; and

FIG. 6 is a flowchart illustrating example process operations executed by the information processing terminal.

### DESCRIPTION OF THE EMBODIMENTS

A personal computer (PC) typically has a relatively large display area and the size of an application screen (window) being displayed can be changed so that a user may be able to view online help while viewing the application screen.

However, the size of an application screen of a device such as an image forming apparatus is basically fixed such that simultaneous display of online help and the application screen may be difficult. In this respect, a pop-up dialog may be displayed on the application screen, for example. However, in this case, all or a part of the application screen may be hidden, and the user may have trouble operating the application screen while viewing the online help.

An aspect of the present invention is directed to providing a technique for minimizing influences on an operation screen of a device while enabling data relating to the operation screen to be viewed.

In the following, embodiments of the present invention are described with reference to the accompanying drawings.

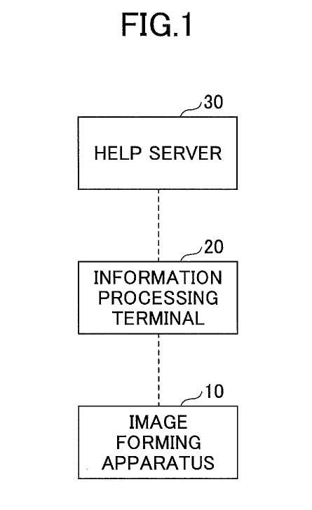

FIG. 1 is a diagram illustrating an example configuration of an information processing system according to a first embodiment of the present invention. The information processing system of FIG. 1 includes an image forming apparatus 10, an information processing terminal 20, and a help server 30. The information processing terminal 20 and the help server 30 are capable of communicating with each other via a wireless LAN (Local Area Network) or mobile communication network, for example. Also, the information processing terminal 20 and the image forming apparatus 10 are capable of communicating with each other via a wireless LAN or a short range wireless communication network, for example.

The image forming apparatus 10 may be a multifunction peripheral (MFP) that implements multiple functions of printing, scanning, copying, facsimile transmission and/or some other image processing function within a single casing. However, the image forming apparatus 10 may also be a device implementing any one of the above functions, for example. Also, the image forming apparatus 10 used in the present embodiment is an example of a device, and in other embodiments, some other type of device such as a projector, a video conference system, a digital camera, or the like may be used instead of the image forming apparatus 10, for example.

The information processing terminal 20 may be a smart device, such as a smartphone or a tablet terminal, for example. However, the information processing terminal 20 does not necessarily have to be a smart device. That is, any mobile terminal that includes a display and is capable of establishing wireless communication can be used as the information processing terminal 20.

The help server 30 may be implemented by at least one computer storing content data (hereinafter referred to as “help data”) of online help associated with an application program (hereinafter referred to as “application”) installed in the image forming apparatus 10.

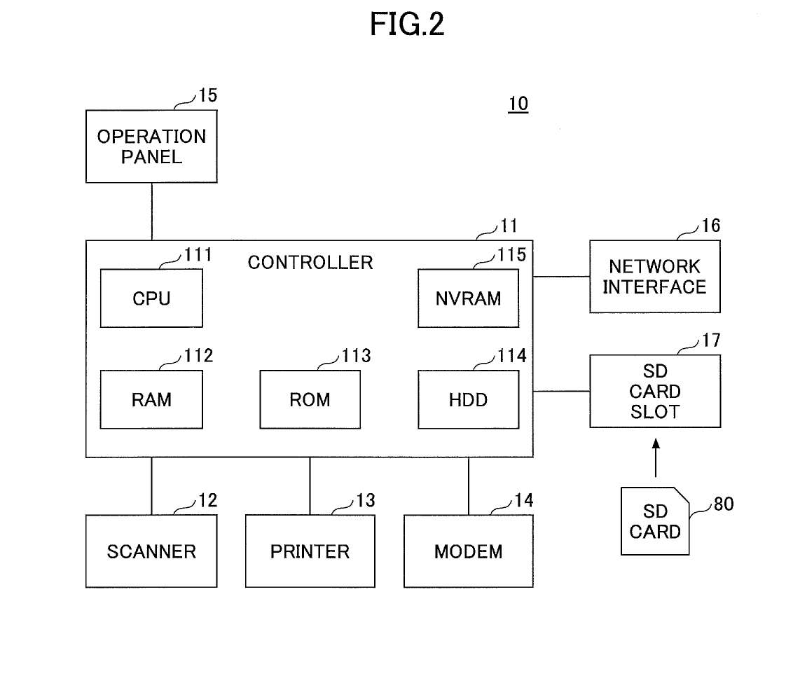

FIG. 2 is a diagram illustrating an example hardware configuration of the image forming apparatus 10 according to the first embodiment. In FIG. 2, the image forming apparatus 10 includes hardware elements, such as a controller 11, a scanner 12, a printer 13, a modem 14, an operation panel 15, a network interface 16, and an SD card slot 17.

The controller 11 includes a CPU (Central Processing Unit) 111, a RAM (Random Access Memory) 112, a ROM (Read-Only Memory) 113, an HDD (Hard Disk Drive) 114, an NVRAM (Non-Volatile Random Access Memory) 115. The ROM 113 stores various programs and data used by these programs, for example. The RAM 112 is used as a storage area for loading a program and a work area for executing the loaded program, for example. The CPU 111 implements various functions by executing a program loaded in the RAM 112. The HDD 114 stores programs and various types of data used by the programs. The NVRAM 115 stores various setting information, for example.

The scanner 12 is hardware for scanning a document and acquiring image data of the document. The printer 13 is hardware for printing print data on a printing medium such as paper. The modem 14 is hardware for establishing connection with a telephone line and is used for transmission and reception of image data through facsimile communication. The operation panel 15 is hardware including an input unit such as buttons for accepting input from a user and a display unit such as a liquid crystal panel, for example. The liquid crystal panel may have a touch panel function, for example. In this case, the liquid crystal panel may also functions as an input unit. The network interface 16 is hardware for establishing connection with a network such as a LAN (wired or wireless). The SD card slot 17 is hardware used for reading a program stored in an SD card 80. That is, in the image forming apparatus 10, not only a program stored in the ROM 113 but also a program stored in the SD card 80 can be loaded into the RAM 112 and executed. Note that the SD card 80 may be replaced by some other type of recording medium, such as a CD-ROM or a USB (Universal Serial Bus) memory, for example. That is, the type of the recording medium that implements the function of the above-described SD card 80 is not limited to a particular type of recording medium. Note that in a case where the SD card 80 is replaced by another type of recording medium, the SD card slot 17 is also replaced by hardware corresponding to the type of the recording medium used.

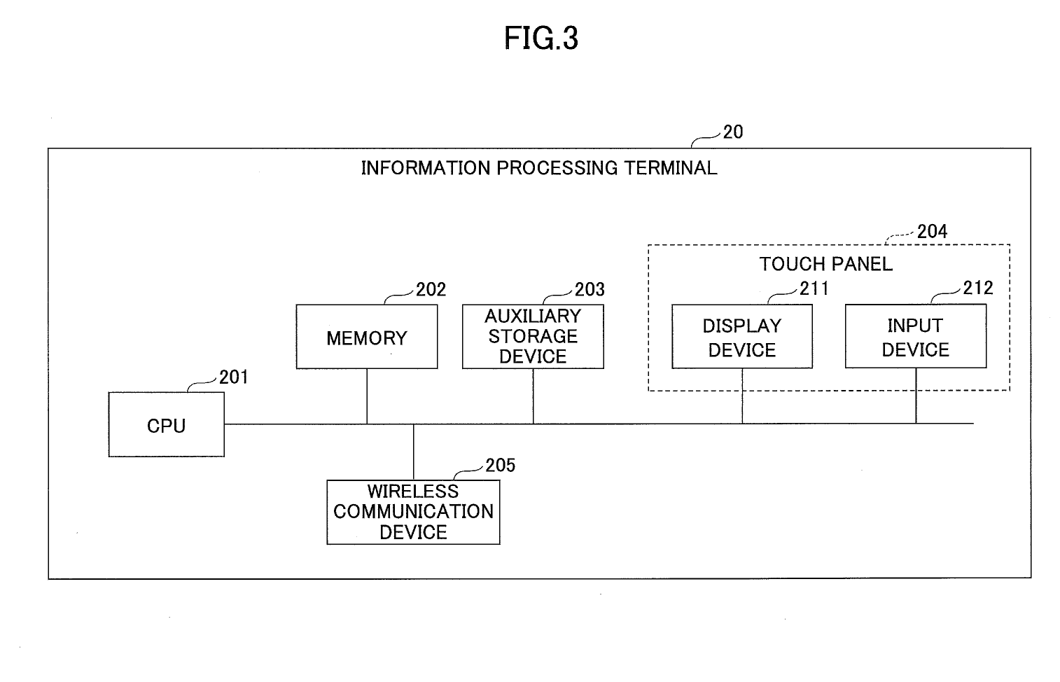

FIG. 3 is a diagram illustrating an example hardware configuration of the information processing terminal 20 according to the first embodiment. In FIG. 3, the information processing terminal 20 includes a CPU 201, a memory 202, an auxiliary storage device 203, a touch panel 204, and a wireless communication device 205.

The auxiliary storage device 203 is an example of a nonvolatile storage unit that stores a program installed in the information processing terminal 20, for example. The memory 202 is an example of a volatile storage unit. For example, when an instruction to start a program is issued, the program may be loaded from the auxiliary storage device 203 into the memory 202. The CPU 201 implements functions of the information processing terminal 20 based on a program stored in the memory 202.

The touch panel 204 is an electronic component having both an input function and a display function. The touch panel 204 displays information and accepts input from a user, for example. The touch panel 204 includes a display device 211 and an input device 212.

The display device 211 may be a liquid crystal display that implements the display function of the touch panel 204. The input device 212 is an electronic component including a sensor for detecting contact of an object with the display device 211. Note that the method used for detecting contact of an object may be any known method, such as an electrostatic method, a resistive film method, or an optical method, for example. Note that the object to be detected may be any object that comes into contact with a contact surface (surface) of the touch panel 204. Examples of such an object include a finger of the user, a dedicated pen, and a general pen.

The wireless communication device 205 is an electronic component such as an antenna for establishing communication over a wireless LAN (Local Area Network) or a mobile communication network, for example.

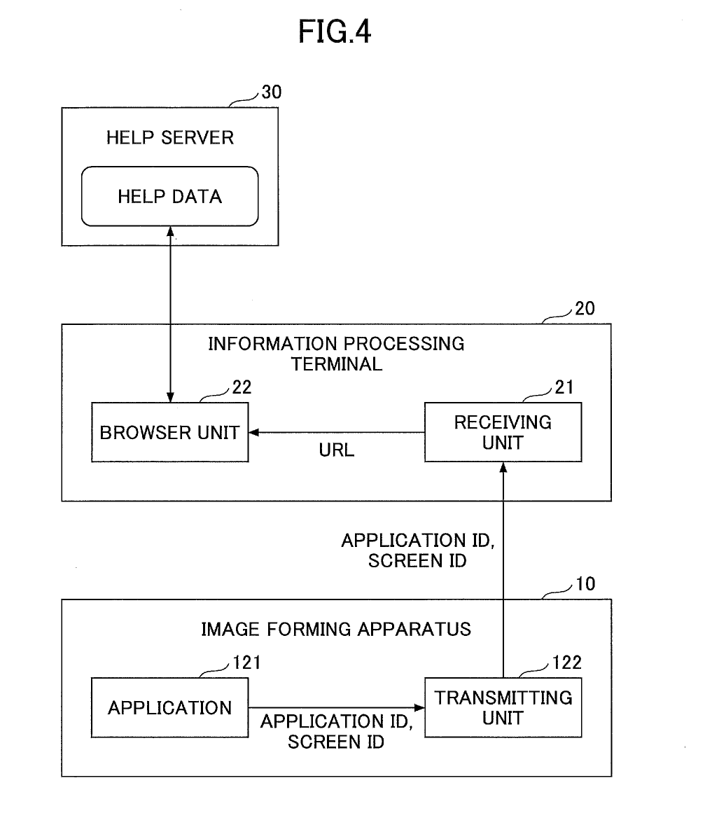

FIG. 4 is a diagram illustrating an example functional configuration of the information processing system according to the first embodiment. In FIG. 4, the image forming apparatus 10 includes at least one application 121 and a transmitting unit 122. These functional elements may be implemented by processes executed by the CPU 111 based on one or more programs installed in the image forming apparatus 10, for example.

The application 121 displays operation screens for accepting operation instructions from a user on the operation panel 15. When the operation screen to be displayed changes, the application 121 communicates identification information associated with the operation screen to be displayed after the screen transition to the transmitting unit 122. In the present embodiment, the application ID and the screen ID constitute such identification information. The application ID is identification information identifying each application 121. The screen ID is identification information identifying each operation screen. Note that in a case where screen IDs of operation screens of different applications 121 do not overlap with one another, the application ID does not have to be communicated to the transmission unit 122.

Upon receiving the application ID and the screen ID, the transmitting unit 122 transmits the application ID and the screen ID to a receiving unit 21 of the information processing terminal 20 through wireless communication.

The information processing terminal 20 includes the receiving unit 21 and a browser unit 22. These units may be implemented by processes executed by the CPU 201 based on one or more programs installed in the information processing terminal 20, for example.

The receiving unit 21 receives the application ID and the screen ID transmitted from the transmitting unit 122 of the image forming apparatus 10. Upon receiving the application ID and the screen ID, the receiving unit 21 generates a URL (Uniform Resource Locator) including the application ID and the screen ID, and inputs the URL to the browser unit 22.

The browser unit 22 downloads and displays help data corresponding to content of the URL input by the help server 30. Note that the browser unit 22 may be implemented by a general web browser, for example.

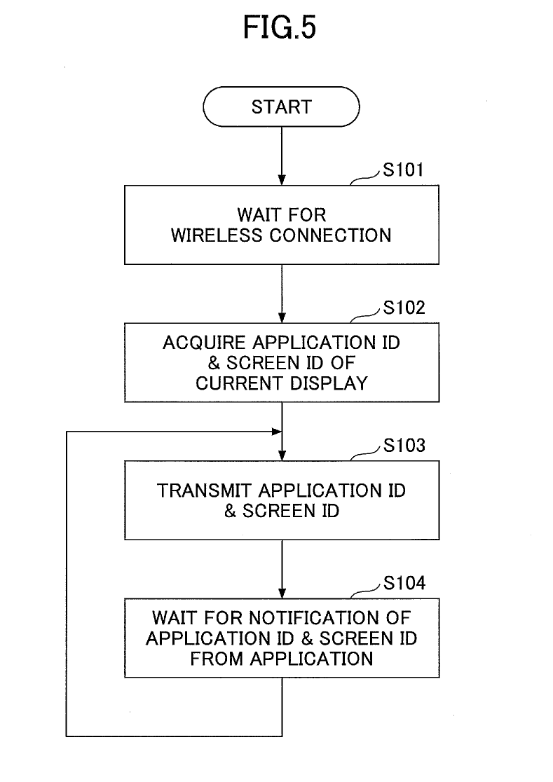

In the following, example process operations executed by the image forming apparatus 10 and the information processing terminal 20 are described. FIG. 5 is a flowchart illustrating example process operations executed by the image forming apparatus 10.

The transmitting unit 122 waits for wireless connection to be established with the information processing terminal 20 (step S101). Then, for example, when the image forming apparatus 10 establishes wireless connection with the information processing terminal 20 that is carried by a user operating the image forming apparatus 10, the transmitting unit 122 acquires from the application 121 currently displaying an operation screen on the operation panel 15 (i.e., the application 121 that is currently used) the application ID of the application 121 and the screen ID of the operation screen currently being displayed (step S102).

Then, the transmitting unit 122 transmits the acquired application ID and screen ID to the receiving unit 21 of the information processing terminal 20 through wireless communication (step S103). Then, the transmitting unit 122 waits for notification of the application ID and the screen ID from the application 121 (step S104). That is, the transmitting unit 122 waits for a screen transition or a change in the application 121 being used, for example. When the transmitting unit 122 receives notification of another application ID and/or screen ID from the application 121, the process returns to step S103.

Note that when the wireless communication with the information processing terminal 20 is disconnected, the process returns to step S101.

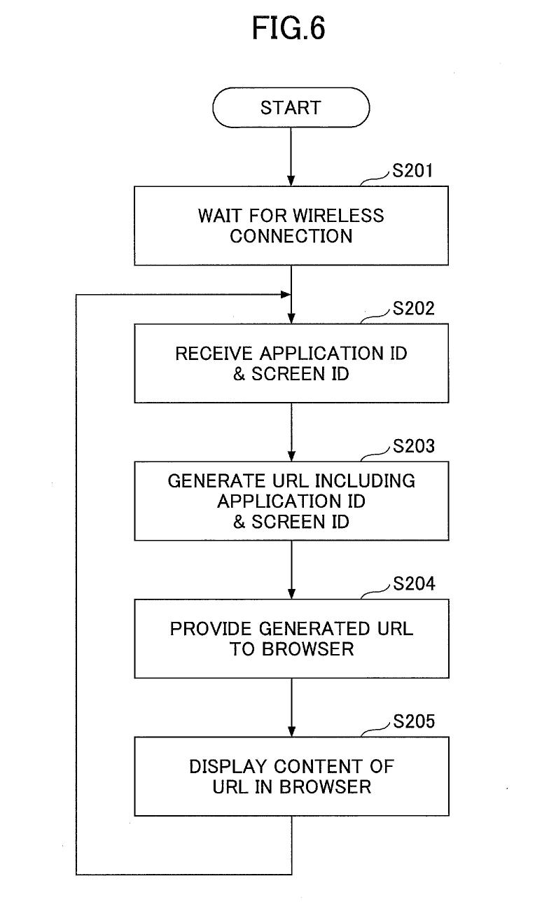

FIG. 6 is a flowchart illustrating example process operations executed by the information processing terminal 20.

The receiving unit 21 waits for wireless connection to be established with the image forming apparatus 10 (step S201). Then, for example, when the user operates the information processing terminal 20 to establish wireless connection with the image forming apparatus 10, the receiving unit 21 waits for an application ID and a screen ID to be transmitted from the transmitting unit 122 (step S202). Upon receiving the application ID and the screen ID, the receiving unit 21 generates a URL including the received application ID and screen ID (step S203). Note that a domain name or an IP address of the help server 30 is included in the URL generated by the receiving unit 21. The domain name or IP address of the help server 30 is set up beforehand in the information processing terminal 20.

Then, the receiving unit 21 provides the generated URL to the browser unit 22 (step S204).

The browser unit 22 downloads help data corresponding to content of the URL from the help server 30, and displays the help data on the display device 211 of the information processing terminal 20 (step S205). In this way, the user can view the help data relating to the operation screen currently being displayed on the operation panel 15 of the image forming apparatus 10 on the display device 211 of the information processing terminal 20.

Note that when the wireless communication with the image forming apparatus 10 is disconnected, the process returns to step S201.

In the embodiment described above, the application ID and the screen ID are transmitted (pushed) from the transmitting unit 122 to the receiving unit 21. However, in other embodiments, the receiving unit 21 may acquire (pull) the application ID and the screen ID from the transmitting unit 122, for example. In this case, the receiving unit 21 may periodically poll the transmitting unit 122 to inquire about the application ID of the application 121 being used and the screen ID of the operation screen being displayed, for example. If there has been a change in at least one of the application ID and the screen ID that has previously been communicated to the receiving unit 21 in response to a previous inquiry regarding the operation screen being displayed, the transmitting unit 122 may respond by communicating the changed application ID and/or screen ID to the receiving unit 21.

Also, in a case where help data is desirably changed according to the model of the image forming apparatus 10, for example, the application 121 may communicate information indicating the model (hereinafter referred to as “model information”) to the transmitting unit 122. In this case, the transmitting unit 122 may transmit the model information in addition to the application ID and the screen ID to the receiving unit 21. In turn, the receiving unit 21 may generate a URL including the model information.

Also, in some embodiments, the application 121 may communicate to the transmitting unit 122 identification information of a display element (display component) being operated (e.g., selected) on the operation screen (hereinafter referred to as “element ID”). In this case, the transmitting unit 122 may transmit the element ID in addition to the application ID and screen ID to the receiving unit 21. In turn, the receiving unit 21 may generate a URL including the element ID, for example. In this way, content data may be provided according to the operation being made on the operation screen, for example.

As described above, according to an aspect of the first embodiment, help data relating to an operation screen being displayed on the operation panel 15 of the image forming apparatus 10 can be displayed on the display device 211 of the information processing terminal 20. Thus, the operation screen being displayed on the image forming apparatus 10 may not be substantially influenced while providing the help data relating to the operation screen to be viewed.

Also, according to an aspect of the present embodiment, the workload for implementing the help functions of the application 121 by a developer (development vendor) of the application 121 may be reduced, for example. For example, the developer may configure the application 121 to transmit the application ID and the screen ID of the operation screen to the transmitting unit 122 and provide the help data in the help server 30.

Note that in the above descriptions, help data is displayed on the information processing terminal 20 as an example of data corresponding to the identification information provided by the application 121. However, other types of data such as advertisement relating to the currently displayed application 121 may be displayed on the information processing terminal 20. Advertisement relating to the application 121 may include advertisement of another application 121 that is frequently used in conjunction with the currently displayed application 121 or advertisement relating to a program capable of enhancing the functions of the currently displayed application 121, for example.

In the following, a second embodiment of the present invention is described. Note that the following descriptions primarily relate to features of the second embodiment that differ from those of the first embodiment. Thus, it may be assumed that features of the second embodiment that are not particularly described below may be substantially identical to those of the first embodiment.

In the second embodiment, a display mode called “help mode” is provided in connection with the operation screens of the application 121. For example, a button for switching to the help mode may be provided at a predetermined position (e.g., upper right corner) of each operation screen. In the help mode, when a display element such as a button on the operation screen is selected by the user, the application 121 does not execute the process that should normally be executed when the display element is selected. Instead, the application 121 communicates the application ID, the screen ID, and the element ID of the display element to the transmitting unit 122. In turn, the transmitting unit 122 transmits the application ID, the screen ID, and the element ID to the receiving unit 21 of the information processing terminal 20. Then, the receiving unit 21 generates a URL including the application ID, the screen ID, and the element ID.

According to an aspect of the second embodiment implementing the above configuration, the user can view help data relating to each display element in the help mode.

Note that in the embodiments described above, the information processing terminal 20 acquires the help data to be displayed from the help server 30. However, in other embodiments, the image forming apparatus 10 may acquire the help data and transmit the acquired help data to the information processing terminal 20, for example.

Also, in some embodiments, the information processing terminal 20 may acquire the application ID and the screen ID by a method other than communication. For example, the application ID and the screen ID, or a two-dimensional code including the application ID and the screen ID may be displayed on the operation panel 15. In this case, the information processing terminal 20 may acquire the application ID and the screen ID by capturing an image of the identification information displayed on the operation panel 15 with a digital camera and analyzing image data of the captured image, for example.

Note that the operation panel 15 is an example of a first display unit. The display device 211 is an example of a second display unit. The browser unit 22 is an example of an acquiring unit.

Although the present invention has been described above with reference to certain illustrative embodiments, the present invention is not limited to these embodiments, and numerous variations and modifications may be made without departing from the scope of the present invention.

Note that a person skilled in the field of information processing technology may implement the present invention using an application specific integrated circuit (ASIC) or an apparatus in which circuit modules are connected.

Further, each of the functions (units) described in connection with the above embodiments may be implemented by one or more circuits.

The one or more circuits described above may include a processor programmed by software to execute a corresponding function, and/or hardware, such as an ASIC or a circuit module, designed to execute a corresponding function, for example.

What is claimed is:

1. An information processing system comprising:
an information processing terminal; and
a device;
wherein the device includes
a first display unit configured to display a screen; and
a transmitting unit configured to transmit identification information relating to the screen being displayed by the first display unit to the information processing terminal; and
wherein the information processing terminal includes
a receiving unit configured to receive the identification information from the device;
an acquiring unit configured to acquire data corresponding to the received identification information; and
a second display unit configured to display the acquired data.

2. The information processing system according to claim 1, wherein
the transmitting unit transmits the identification information relating to the screen being displayed to the information processing terminal each time the screen displayed by the first display unit changes.

3. The information processing system according to claim 1, wherein the identification information includes information identifying a program causing the device to display the screen on the first display unit.

4. The information processing system according to claim 1, wherein the identification information includes information identifying an element being operated on the screen being displayed.

5. The information processing system according to claim 1, wherein the identification information includes information indicating a model of the device.

6. An information processing method that is executed by an information processing system including an information processing terminal and a device, the method comprising:
the device displaying a screen on a first display unit;
the device transmitting identification information relating to the screen being displayed on the first display unit to the information processing terminal;
the information processing terminal receiving the identification information from the device;
the information processing terminal acquiring data corresponding to the received identification information; and
the information processing terminal displaying the acquired data on a second display unit.

7. The information processing method according to claim 6, wherein
the device transmits the identification information relating to the screen being displayed to the information processing terminal each time the screen displayed by the first display unit changes.

8. The information processing method according to claim 6, wherein the identification information includes information identifying a program causing the device to display the screen on the first display unit.

9. The information processing method according to claim 6, wherein the identification information includes information identifying an element being operated on the screen being displayed.

10. The information processing method according to claim 6, wherein the identification information includes information indicating a model of the device.

11. A computer program product comprising a non-transitory computer-readable medium having a program recorded thereon that is executable by a device connected to an information processing terminal via a network, the program when executed causing the device to implement processes of:
displaying a screen on a first display unit; and
transmitting identification information relating to a screen being displayed on the first display unit to the information processing terminal;
wherein the information processing terminal implements processes of
receiving the identification information from the device;
acquiring data corresponding to the received identification information; and
displaying the acquired data on a second display unit.

12. The computer program product according to claim 11, wherein the program causes the device to transmit the identification information relating to the screen being displayed to the information processing terminal each time the screen displayed by the first display unit changes.

13. The computer program product according to claim 11, wherein the identification information includes information identifying the program causing the device to display the screen on the first display unit.

14. The computer program product according to claim 11, wherein the identification information includes information identifying an element being operated on the screen being displayed.

15. The computer program product according to claim 11, wherein the identification information includes information indicating a model of the device.
